(19) United States
(12) Patent Application Publication
(10) Pub. No.: US 2004/0153987 A1
(43) Pub. Date: Aug. 5, 2004

(54) Method and system for connecting computer-generated rectangles

(76) Inventor: Jason Harold Culler, Livermore, CO (US)

Correspondence Address: HEWLETT-PACKARD COMPANY, Intellectual Property Administration, P.O. Box 272400, Fort Collins, CO, 80527-2400, US

(21) Appl. No.: 10/356,078

(22) Filed: Jan. 31, 2003

(51) Int. Cl. G06F 17/50; G06F 9/45; G06F 9/455

(52) U.S. Cl. 716/11; 716/8

(57) ABSTRACT

An embodiment of the invention provides an improved method and system for joining computer-generated rectangles by a mask designer. The improved method first selects the first rectangle to be connected and connects a second rectangle to the first. Next, an orthogonal route is traced to the third rectangle to be connected by identifying specific points between the first and the third rectangles. After identifying the orthogonal route, the area around the last specified point is zoomed in on. Next, the third rectangle is identified. Finally, after identifying the third rectangle, the second is connected to the first and third rectangles with the same width as the width of the first or third triangle and the length defined by the orthogonal route.

### FIELD OF THE INVENTION

This invention relates generally to integrated circuits. More particularly, this invention relates to CAD tools and physical design work.

### BACKGROUND OF THE INVENTION

Integrated circuits (ICs) comprise a plurality of electronic components that function together to implement a higher-level function. ICs are formed by implanting a pattern of transistors into a silicon wafer which are then connected to each other by layering multiple layers of metal materials, interleaved between dielectric material, over the transistors. The fabrication process entails the development of a schematic diagram that defines the circuits to be implemented. A chip layout is generated from the schematic. The chip layout, also referred to as the artwork, comprises a set of planar geometric shapes over several layers that implement the circuitry defined by the schematic. A mask is then generated for each layer based on the chip layout. Each metal is then successively manufactured over the silicon wafer according to the layer's associated mask using a photolithographical technique.

The process of converting the specifications of an electrical circuit schematic into the layout is called the physical design process. CAD (Computer Aided Design) tools are extensively used during all stages of the physical design process. In addition, much time is spent placing geometric shapes by “hand.” Because IC's are becoming more and more complex, the time required to physically design a chip has increased.

In order to reduce the time required to physically design an IC, CAD tools have been developed that automatically lay out portions of the IC. However, there are portions of the design that require custom design by a mask designer. A mask designer creates geometric shapes on a computer screen and then connects them in a manner that represents the electrical circuit schematic. Often times a mask designer can create circuits that are smaller and faster than the circuits that can be automatically created by CAD tools.

Part of the time used by a mask designer when laying out ICs involves “zooming” in and out on portions of the physical layout displayed on a computer screen. Zooming out enables the mask designer to look at a larger part of the IC. By zooming out the mask designer can make decisions about global routing, area minimization, or ground rule violations. However, it is difficult to connect small geometric shapes together when the display of the IC is zoomed out. As consequence, when the display is zoomed out and a mask designer wants to make connections to small geometric shapes, he is required to zoom in until he can see what connections are appropriate.

There is a need in the art to reduce the number of computer interactions required by a mask designer to design artwork for modern integrated circuits. The current invention reduces the number of computer interactions required by a mask designer to connect a rectangle between two other rectangles.

### SUMMARY OF THE INVENTION

An embodiment of the invention provides an improved method and system for joining computer-generated rectangles by a mask designer. The improved method first selects the first rectangle to be connected and connects a second rectangle to the first. Next, an orthogonal route is traced to the third rectangle to be connected by identifying specific points between the first and the third rectangles. After identifying the orthogonal route, the area around the last specified point is zoomed in on. Next, the third rectangle is identified. Finally, after identifying the third rectangle, the second is connected to the first and third rectangles with the same width as the width of the first or third triangle and the length defined by the orthogonal route.

Other aspects and advantages of the present invention will become apparent from the following detailed description, taken in conjunction with the accompanying drawing, illustrating by way of example the principles of the invention.

### BRIEF DESCRIPTION OF THE DRAWINGS

FIG. 1 is a block diagram showing two blocks with rectangles. Prior Art

FIG. 2 is drawing showing one rectangle abutted to another rectangle. Prior Art

FIG. 3 is a block diagram illustrating the routing of a rectangle. Prior Art

FIG. 4 is drawing showing one rectangle abutted to another rectangle. Prior Art

FIG. 5 is a block diagram illustrating the routing of a rectangle. Prior Art

FIG. 6 is drawing showing one rectangle abutted to another rectangle. Prior Art

FIG. 7 is a block diagram illustrating the routing of a rectangle. Prior Art

FIG. 8 is drawing showing one rectangle abutted to another rectangle. Prior Art

FIG. 9 is a block diagram illustrating the routing of a rectangle. Prior Art

FIG. 10 is drawing showing one rectangle abutted to another rectangle. Prior Art

FIG. 11 is a block diagram showing two blocks with rectangles.

FIG. 12 is drawing showing one rectangle abutted to another rectangle.

FIG. 13 is a block diagram showing the path where a rectangle will later be routed.

FIG. 14 is drawing showing a group of rectangles.

FIG. 15 is drawing showing one rectangle abutted to another rectangle.

FIG. 16 is a block diagram illustrating the routing of a rectangle.

### DETAILED DESCRIPTION OF THE PREFERRED EMBODIMENT

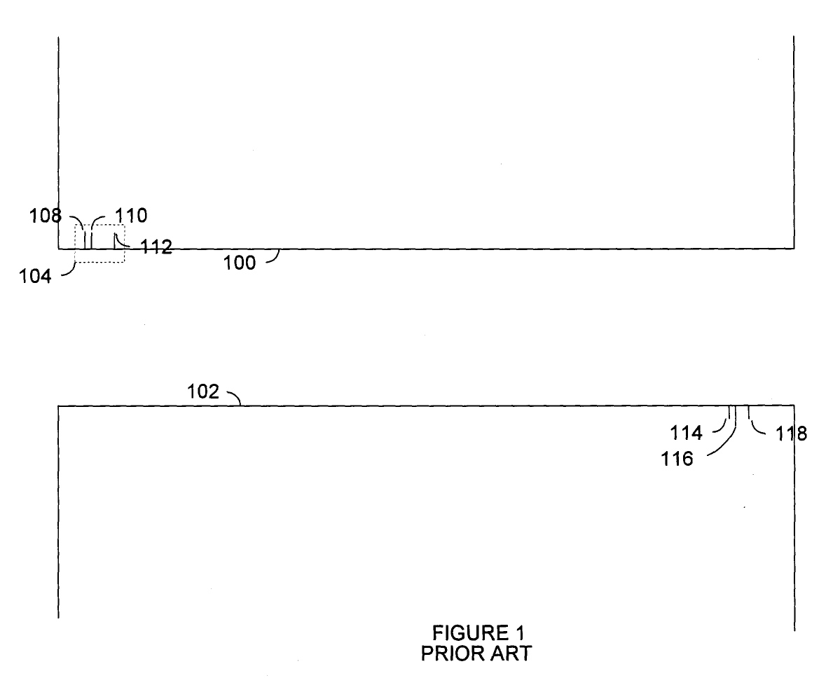

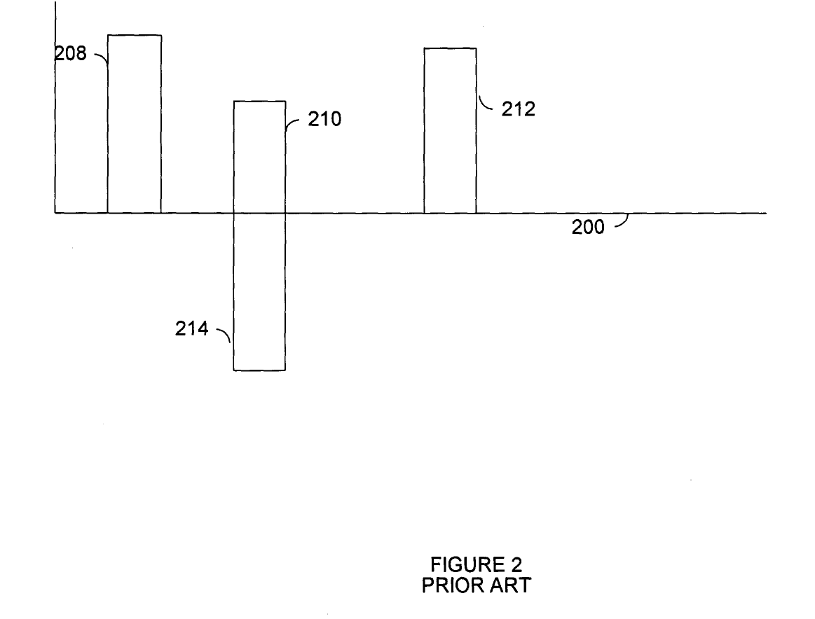

FIG. 1 represents two blocks 100 and 102, that contain circuitry. Each block, 100 and 102, contains rectangles, that may be connected to other rectangles. The upper block, 100, contains rectangles 108, 110, and 112. The dashed-box, 104, indicates the area that will be “zoomed” in FIG. 2. The lower block, 102, contains rectangles 114, 116, and 118. In this example the steps needed to connect rectangle 110 to rectangle 118 will be demonstrated. FIG. 1 is a view of artwork that is zoomed out in order to determine the route needed to connect rectangles 110 and 118. Because the view in FIG. 1 is zoomed out, the rectangles shown, 108, 110, 112, 114, 116, and 118 appear only as lines. In order to view them as rectangles and add another rectangle to rectangle 110, the area, 104, near rectangles 108, 110, and 122, should be zoomed. FIG. 2 shows the zoomed in area.

FIG. 2 shows a rectangle, 214, added to rectangle 210. In order to abut rectangle 214 to rectangle 210, the area near them is zoomed in. After zooming in, it is possible to look at the available rectangles, 208, 210, and 212 on upper block 200.

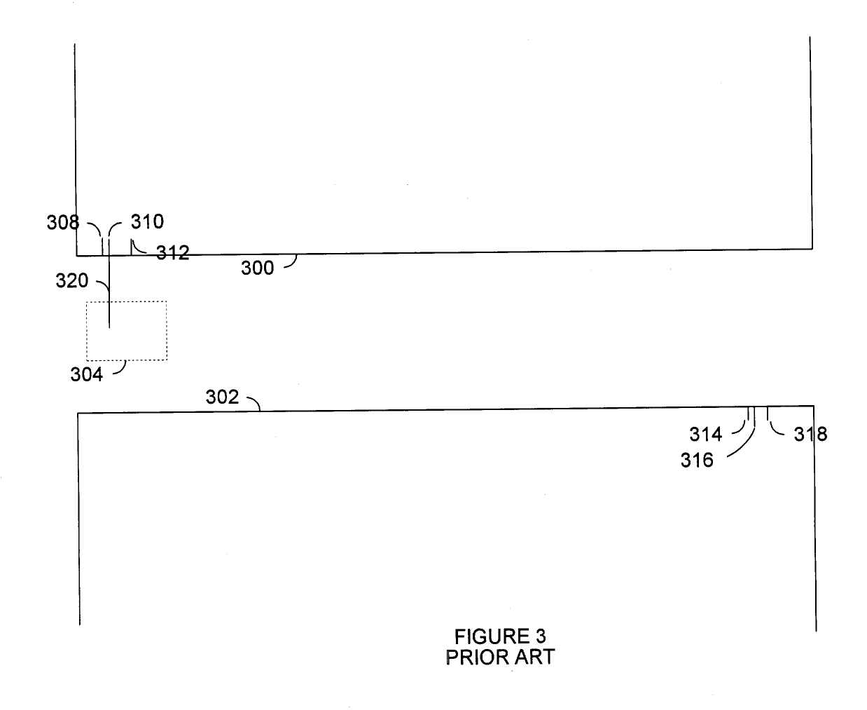

In order to route rectangle 214 to another location, the area being viewed must be zoomed out. FIG. 3 is an illustration of zooming out. From this view, it can be seen that rectangle 320 was stretched to the middle of the window. In this example, we want to connect rectangle 320 to rectangle 318. Dashed-box, 304, shows the next area that must be zoomed in order to abut a rectangle to rectangle 320.

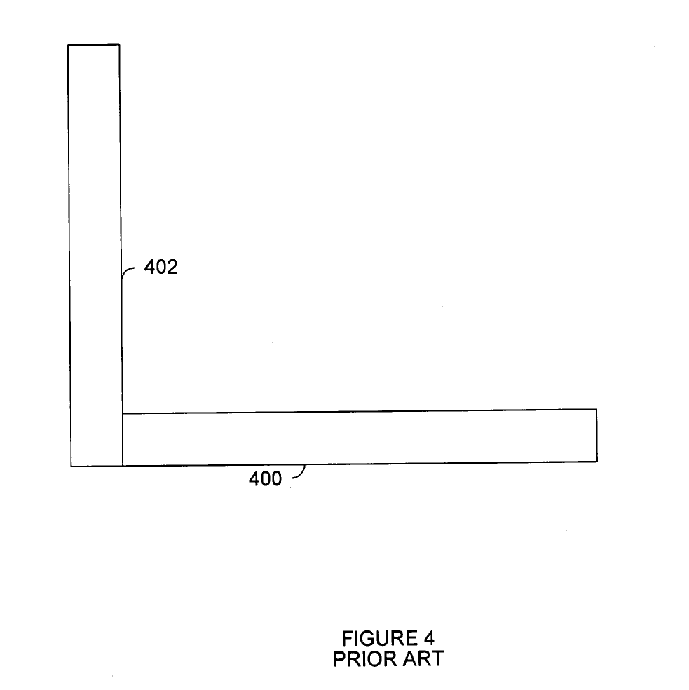

FIG. 4 shows a rectangle, 400, added to rectangle 402. In order to abut rectangle 400 to rectangle 210, the area near them is zoomed in. After zooming in and adding rectangle 400, rectangle 400 must be stretched to the right to make a connection in the lower block, 102, shown in FIG. 1.

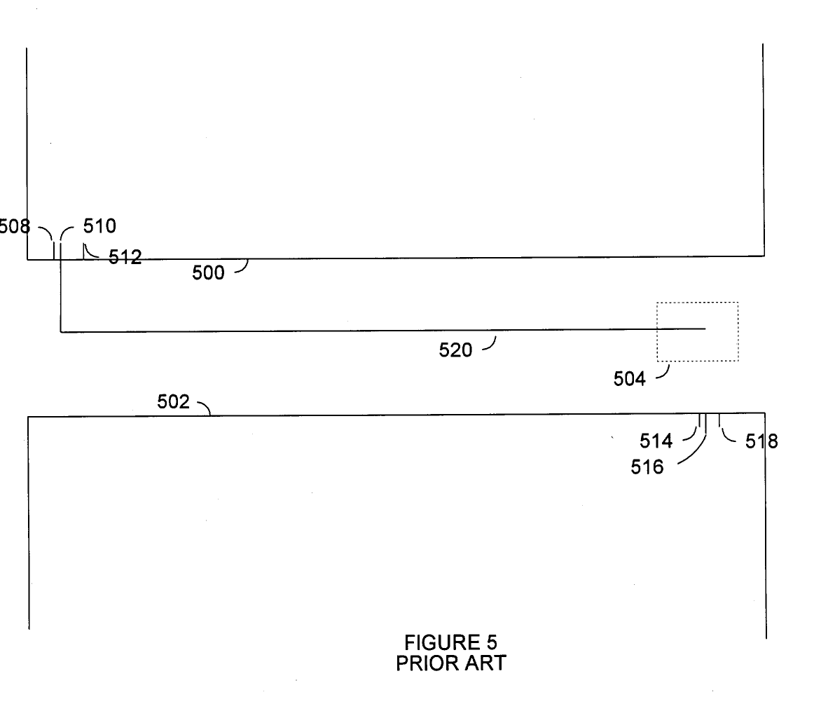

In order to route rectangle 400 to another location, the area being viewed must be zoomed out. FIG. 5 is an illustration of zooming out. From this view, it can be seen that rectangle 520 was stretched from the left to the right of the window. In this example, we want to connect rectangle 520 to rectangle 518. Dashed-box, 504, shows the next area that must be zoomed in order to abut a rectangle to rectangle 520.

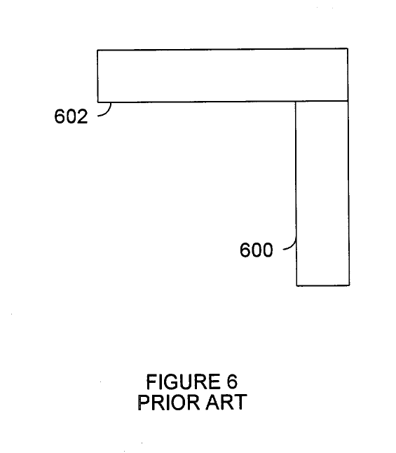

FIG. 6 shows a rectangle, 600, added to rectangle 602. In order to abut rectangle 600 to rectangle 602, the area near them is zoomed in. After zooming in and adding rectangle 600, rectangle 600 must be stretched toward the lower block, 102, shown in FIG. 1.

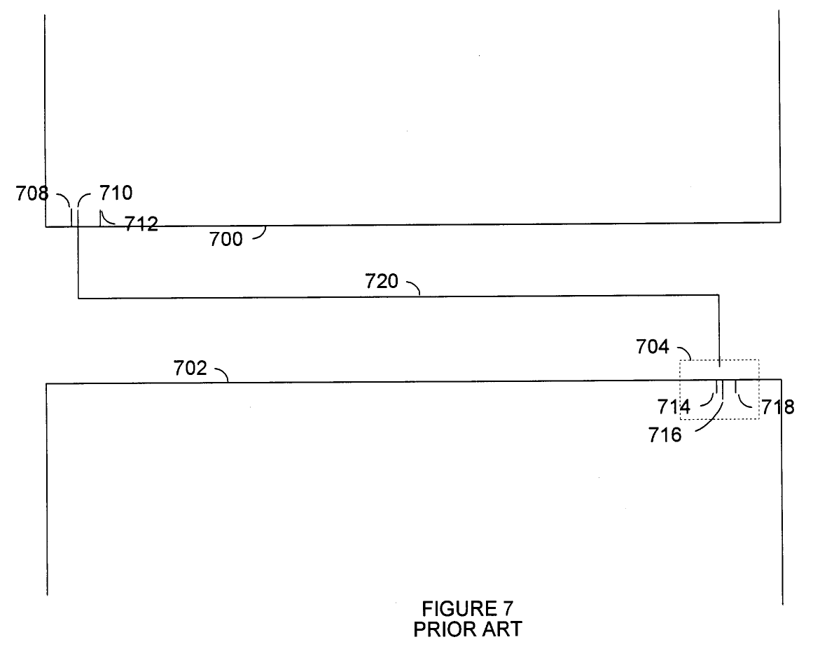

In order to route rectangle 600 to another location, the area being viewed must be zoomed out. FIG. 7 is an illustration of zooming out. From this view, it can be seen that rectangle 720 was stretched from the middle-right of the window to near the right side of the lower block, 702. In this example, we want to connect rectangle 720 to rectangle 718. Dashed-box, 704, shows the next area that must be zoomed in order to abut a rectangle to rectangle 718.

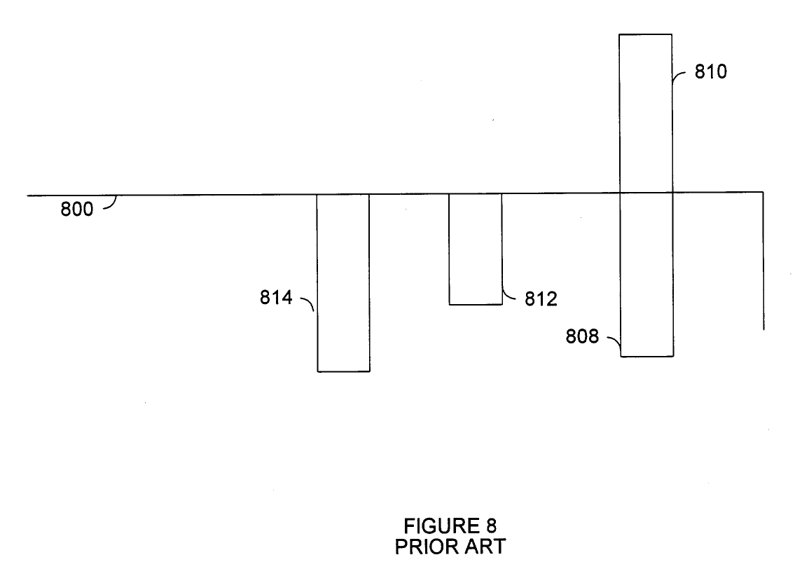

FIG. 8 shows a rectangle, 810, added to rectangle 808. In order to abut rectangle 810 to rectangle 808, the area near them is zoomed in. After zooming in and adding rectangle 810, the view must be zoomed out in order to connect rectangle 810 to 720.

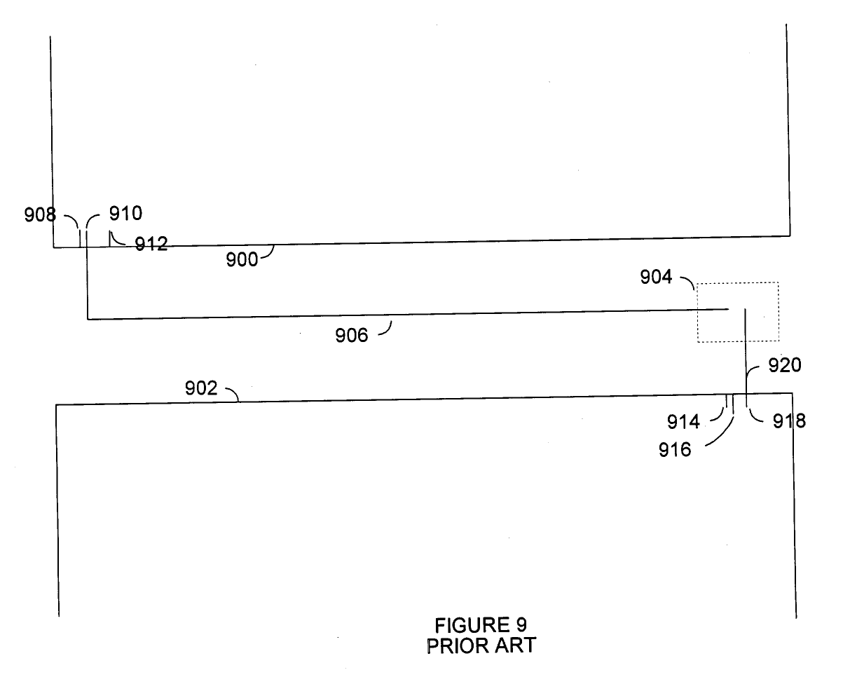

FIG. 9 is an illustration of zooming out. From this view, it can be seen that rectangle 906 should be stretched to connect to rectangle 920. In this example, we want to connect rectangle 906 to rectangle 920. Dashed-box, 904, shows the next area that must be zoomed in order to abut a rectangle to rectangle 906 to rectangle 920.

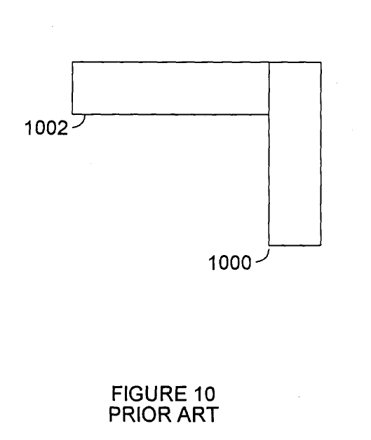

FIG. 10 shows rectangle 1002 stretched to abut to rectangle 1000. After making this connection the route is complete.

The previous example requires many zoom ins and zoom outs and as a result requires a great deal of time to implement. An embodiment of the present invention reduces the time required to route a rectangle from one point to another.

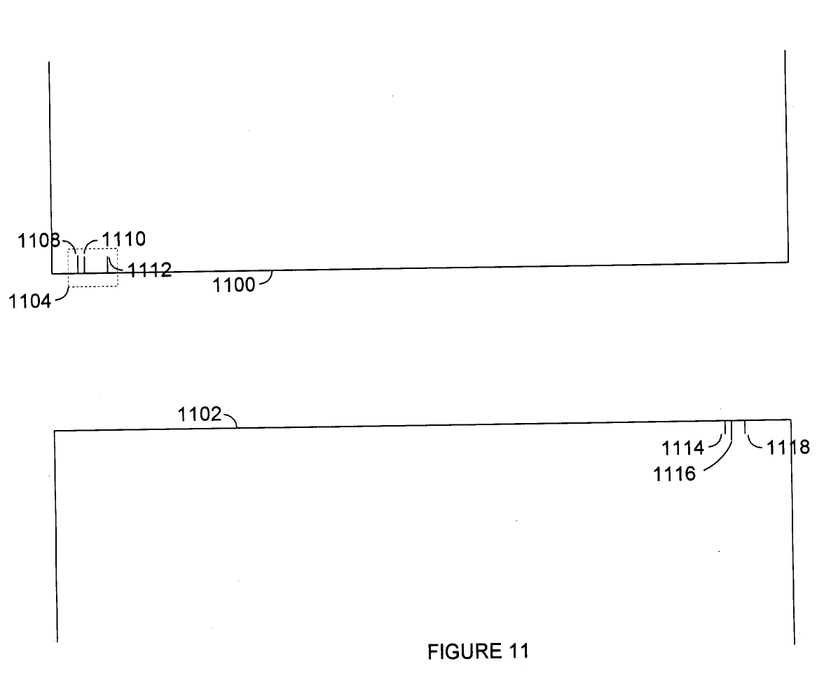

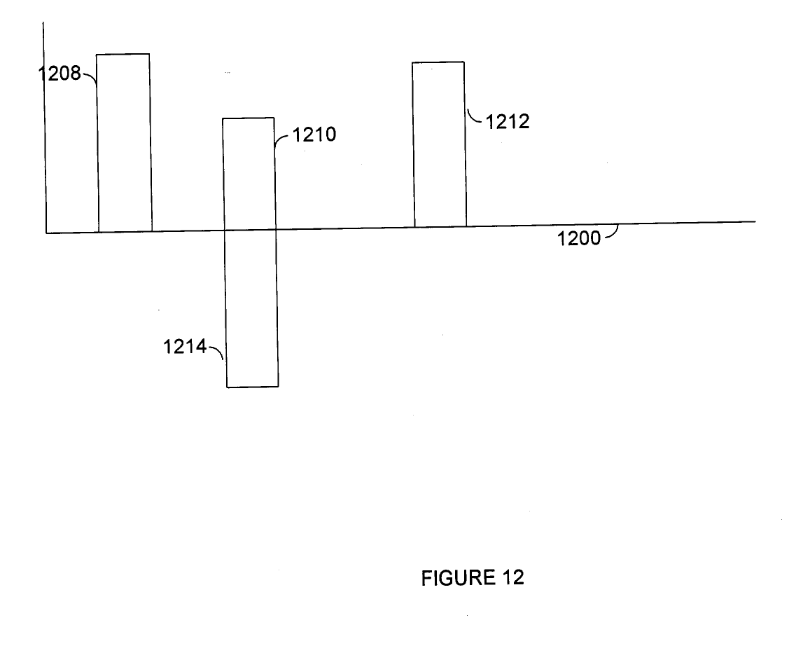

FIG. 11 represents two blocks 1100 and 1102 that contain circuitry. Each block, 1100 and 1102 contains rectangles that may be connected to other rectangles. The upper block, 1100, contains rectangles 1108, 1110, and 1112. The dashed-box, 1104, indicates the area that will be “zoomed” in FIG. 12. The lower block, 1102, contains rectangles 1114, 1116, and 1118. In this example the steps needed to connect rectangle 1110 to rectangle 1118 will be demonstrated. FIG. 11 is a view of artwork that is zoomed out in order to determine the route needed to connect rectangles 1110 and 1118. Because the view in FIG. 11 is zoomed out, the rectangles shown, 1108, 1110, 1112, 1114, 1116, and 1118 appear only as lines. In order to view them as rectangles and add another rectangle to rectangle 1110, the area, 1104, near rectangles 1108, 1110, and 1122, should be zoomed. FIG. 12 shows the zoomed in area.

FIG. 12 shows a rectangle, 1214, added to rectangle 1210. In order to abut rectangle 1214 to rectangle 1210, the area near them is zoomed in. After zooming in, it is possible to look at the available rectangles, 1208, 210, and 212 on upper block 200. In this embodiment, “double-clicking” on rectangle 1214 indicates that the area shown by 1104, should be zoomed out. Subsequent zooming out may be accomplished by double-clicking again.

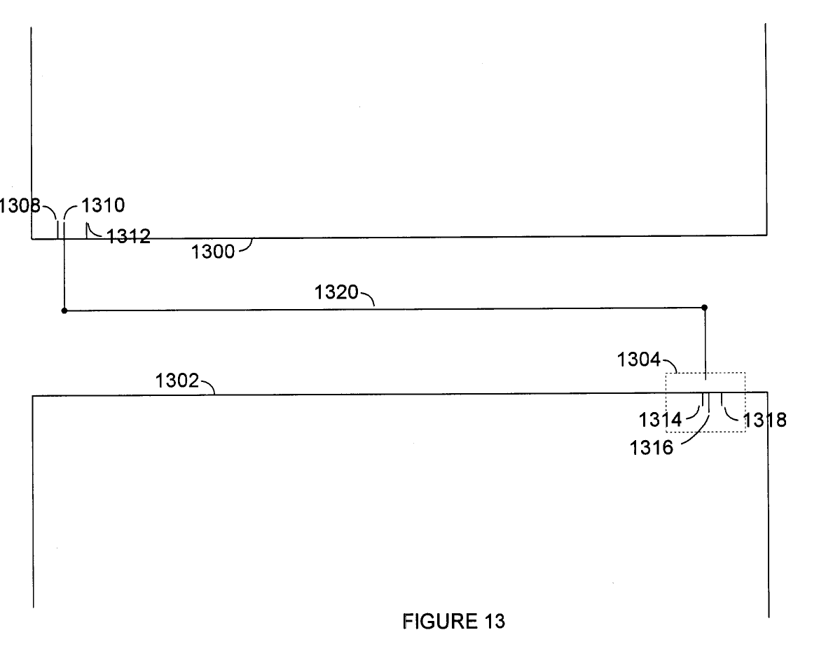

After zooming out to the appropriate level, an orthogonal line is drawn from the upper left block, 1300 to near the rectangle, 1318. FIG. 13 show the path, 1320, created by drawing this line. This line is created without zooming in.

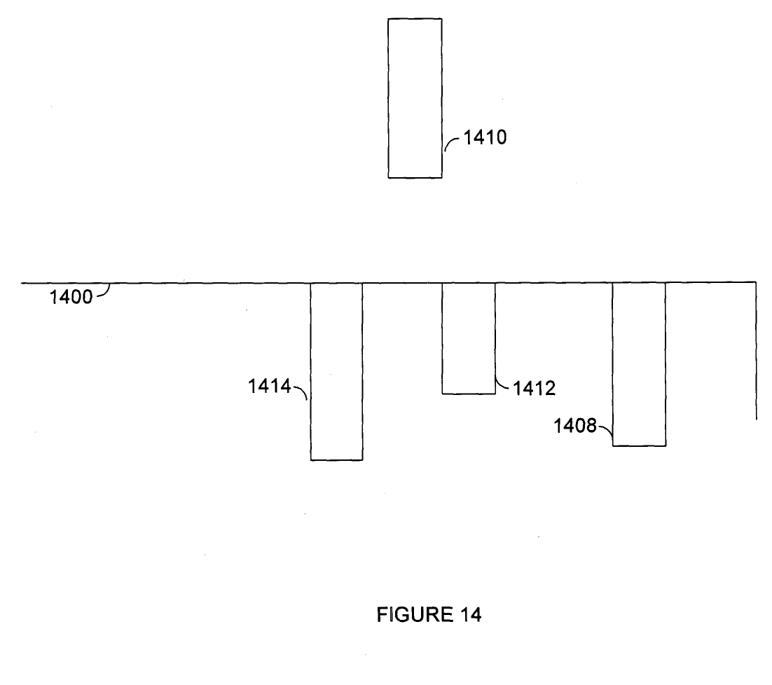

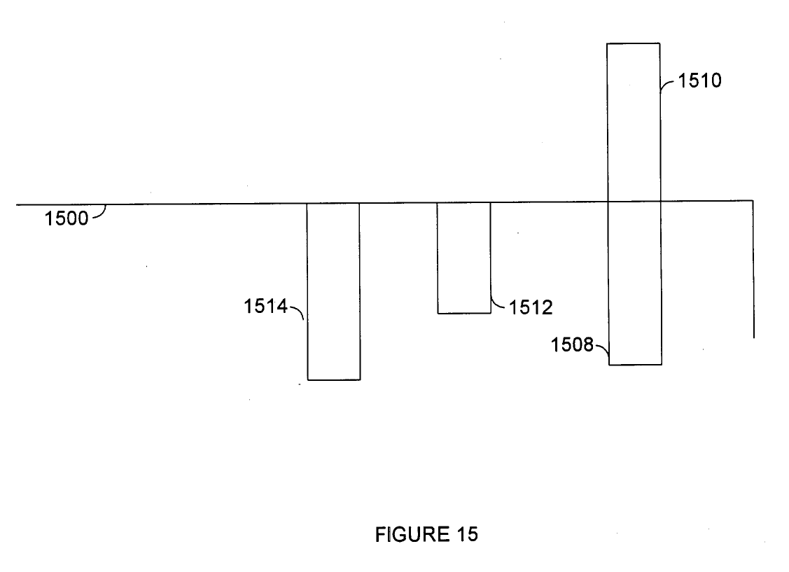

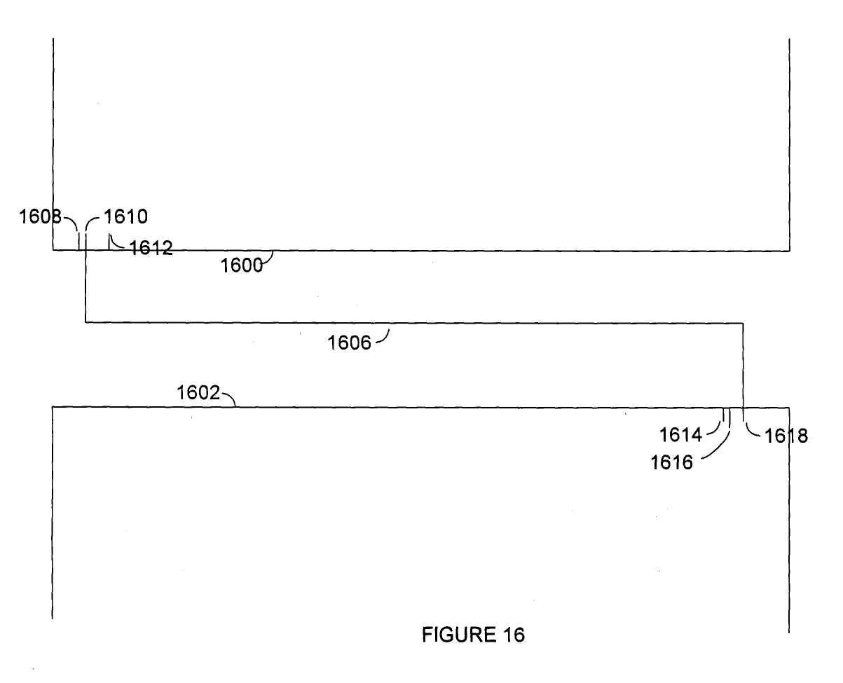

After drawing the orthogonal line, the area indicated by the dashed-box, 1304, is zoomed in. FIG. 14 shows the zoomed in area. Clicking on rectangle 1408 indicates that rectangle 1410 should be abutted to rectangle 1408. FIG. 15 shows the abutted rectangles, 1510 and 1508. In addition to abutting the rectangles, 1510 and 1508, the clicking creates a rectangle, 1606 that connects rectangle 1610 to rectangle 1618 as show in FIG. 16.

The rectangle, 1606, created by this operation requires fewer zoom ins and zoom outs. As a consequence, the design time required for mask designers to lay out integrated circuits is reduced. The rectangle, 1606, created by this process is not guaranteed to pass design rule checks. For example, the rectangle, 1606, may be too close to another piece of metal and violates a spacing rule.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) An improved method for joining computer generated rectangles comprising:
a) identifying a first rectangle;
b) connecting a second rectangle to the first rectangle;
c) identifying an orthogonal route where the second rectangle will be placed by identifying specific points between the first rectangle and a third rectangle;
d) zooming in on the area around the last point specified in step c;
e) identifying the third geometric shape;
f) connecting the second rectangle to the third rectangle;
f) such that the width of the second rectangle is the same as the width of the third rectangle;
g) such that the length of the second rectangle follows the orthogonal route defined in step c.

2) An improved method for joining computer generated rectangles comprising:
a) identifying a first rectangle;
b) connecting a second rectangle to the first rectangle;
c) identifying an orthogonal route where the second rectangle will be placed by identifying specific points between the first rectangle and a third rectangle;
d) zooming in on the area around the last point specified in step c;
e) identifying the third geometric shape;
f) connecting the second rectangle to the third rectangle;
f) such that the width of the second rectangle is the same as the width of the first rectangle;
g) such that the length of the second rectangle follows the orthogonal route defined in step c.

3) A computer-readable medium having computer-executable instructions that allows a person to join computer generated rectangles comprising:
a) identifying a first rectangle;
b) connecting a second rectangle to the first rectangle;
c) identifying an orthogonal route where the second rectangle will be placed by identifying specific points between the first rectangle and a third rectangle;
d) zooming in on the area around the last point specified in step c;
e) identifying the third geometric shape;
f) connecting the second rectangle to the third rectangle;
f) such that the width of the second rectangle is the same as the width of the third rectangle;
g) such that the length of the second rectangle follows the orthogonal route defined in step c.

4) A computer-readable medium having computer-executable instructions that allows a person to join computer generated rectangles comprising:
a) identifying a first rectangle;
b) connecting a second rectangle to the first rectangle;
c) identifying an orthogonal route where the second rectangle will be placed by identifying specific points between the first rectangle and a third rectangle;
d) zooming in on the area around the last point specified in step c;
e) identifying the third geometric shape;
f) connecting the second rectangle to the third rectangle;
f) such that the width of the second rectangle is the same as the width of the first rectangle;
g) such that the length of the second rectangle follows the orthogonal route defined in step c.

5) A computer system that allows a person to join computer generated rectangles comprising:
a) a storage medium;
b) a software program stored on the storage medium, said software comprising a set of instructions for:
1) identifying a first rectangle;
2) connecting a second rectangle to the first rectangle;
3) identifying an orthogonal route where the second rectangle will be placed by identifying specific points between the first rectangle and a third rectangle;
4) zooming in on the area around the last point specified in step 3;
5) identifying the third geometric shape;
6) connecting the second rectangle to the third rectangle;
7) such that the width of the second rectangle is the same as the width of the third rectangle;
8) such that the length of the second rectangle follows the orthogonal route defined in step 3.

6) A computer system that allows a person to join computer generated rectangles comprising:
a) a storage medium;
b) a software program stored on the storage medium, said software comprising a set of instructions for:
1) identifying a first rectangle;
2) connecting a second rectangle to the first rectangle;
3) identifying an orthogonal route where the second rectangle will be placed by identifying specific points between the first rectangle and a third rectangle;
4) zooming in on the area around the last point specified in step 3;
5) identifying the third geometric shape;
6) connecting the second rectangle to the third rectangle;
7) such that the width of the second rectangle is the same as the width of the first rectangle;
8) such that the length of the second rectangle follows the orthogonal route defined in step 3.
